(19) United States
(12) Patent Application Publication
(10) Pub. No.: US 2011/0200237 A1
(43) Pub. Date: Aug. 18, 2011

(54) PATTERN MATCHING DEVICE AND PATTERN MATCHING METHOD

(75) Inventors: Yoichi Nakamura, Tokyo (JP); Toshio Kamei, Tokyo (JP)

(73) Assignee: NEC CORPORATION, TOKYO (JP)

(21) Appl. No.: 13/124,262

(22) PCT Filed: Oct. 13, 2009
(86) PCT No.: PCT/JP2009/005326

§ 371 Date: Apr. 14, 2011

(30) Foreign Application Priority Data
Oct. 15, 2008 (JP) 2008-266792

(51) Int. Cl. G06K 9/00

(52) U.S. Cl. 382/127; 382/115; 382/124

(57) ABSTRACT

A pattern matching device 1 includes an image obtaining unit 101 that obtains an image of a subject containing plural types of biometric patterns. Further, the pattern matching device 1 includes a separation-and-extraction unit 102 that separates and extracts the plural types of biometric patterns from the image. Yet further, the pattern matching device 1 includes a matching unit 103 that matches the separated and extracted plural types of biometric patterns against pre-registered biological information for matching, thereby to derive plural matching results.

### TECHNICAL FIELD

The present invention relates to a pattern matching device and a pattern matching method. In particular, the present invention relates to a pattern matching device and a pattern matching method for verifying an individual using a fingerprint pattern and a pattern of a blood vessel such as a vein.

### BACKGROUND ART

In recent years, automated-teller machines, electronic commerce systems, door lock systems and the like have employed a matching operation based on biological information specific to each individual (fingerprint pattern, blood vessel pattern such as vein, iris of eye, voice print, face, palm shape, etc.) as a means for identifying users. Further, there is proposed a technique for enhancing reliability of matching results by combining plural types of the biological information described above at the time of the matching operation.

As a technique of this type, Patent Document 1 (Japanese Patent Application Laid-open No. 2008-20942) describes an individual identification device that operates as below. At a time of reading a fingerprint pattern and a vein pattern, a light source section alternately emits an infrared light having a wavelength λa suitable for reading the vein pattern and an infrared light having a wavelength λb suitable for reading the fingerprint pattern at predetermined detection intervals, and a light-receiving sensor section alternately detects the vein pattern and the fingerprint pattern in a time-division manner. Signals detected by the light-receiving sensor section are amplified by an amplification section, are converted by an analog/digital conversion section into digital signals suitable for signal processes, and are distributed by a data distribution section to two channels as vein pattern data and fingerprint pattern data. Based on the vein pattern data and the fingerprint pattern data distributed by the data distribution section, an identification result can be obtained by a processing section that identifies an individual using the vein pattern data and the fingerprint pattern data.

Further, Patent Document 2 (Japanese Patent Application Laid-open No. 2007-175250) describes a biometric authentication device that operates as below. The biometric authentication device has an image capturing device and an illumination device for capturing an image of a fingerprint disposed on a side where the fingerprint of a person to be authenticated exists, and an illumination device for capturing an image of a vein on a side where the fingerprint of the person to be authenticated does not exist. The illumination device for capturing the image of the fingerprint employs a light source with a visible light or a light source that emits a light having a wavelength suitable for making the fingerprint conspicuous, and the illumination device for capturing the image of the vein employs a light source suitable for passing through a skin and making the vein conspicuous similar to a case of infrared light. At the time of capturing the image of the fingerprint, the image of the fingerprint is captured by the image capturing device while the illumination device for capturing the image of the fingerprint is being lit and the illumination device for capturing the image of the vein is in a turned-off state. At the time of capturing the image of the vein, the image of the vein is captured by the image capturing device while the illumination device for capturing the image of the fingerprint is in a turned-off state and the illumination device for capturing the image of the vein is being lit. Then, matching is performed between the captured images and data stored in a storage section, whereby matching results can be obtained.

Yet further, Patent Document 3 (Japanese Patent Application Laid-open No. 2007-179434) describes an image reading device that operates as below. A finger is closely contacted on a detection surface side of a sensor array and on one surface of a frame member, and a white LED or an infrared light LED disposed on the other side of the sensor array and the frame member is selectively emitted to operate driving control of the sensor array, whereby the fingerprint image or vein image of the finger can be read.

Yet further, Patent Document 4 (Japanese Patent Application Laid-open No. 2007-323389) describes a solid-state imaging device that operates as below. The solid-state imaging device includes a solid-state imaging element and two types of color filters, and the solid-state imaging device captures an image of a subject to be imaged by subjecting a light incident upon a surface of the solid-state imaging element to photoelectric conversion. The two types of color filters provided on the surface of the solid-state imaging element are filters that allow lights having two types of wavelength bands to pass through. With the wavelength bands, a first image containing a fingerprint pattern and a second image containing the fingerprint pattern and a vein pattern can be captured at the same time. Then, a difference calculation process of subtracting the fingerprint pattern in the first image from the fingerprint pattern and the vein pattern in the second image is performed, whereby it is possible to obtain the vein pattern.

Yet further, Patent Document 5 (WO 2005/046248) describes an image pick-up device that operates as below. A light from an object is split into two light paths by a half mirror. A light of one light paths of the two light paths passes through an infrared light cut filter, and is cut off its near-infrared light, so that a CCD imaging element obtains a general 3-band image. The other light passes through a band pass filter that allows lights having about half bands of the respective wavelength bands of RGB to pass through, whereby the CCD imaging element can obtain a 3-band image having a spectral characteristic in which the spectral band thereof is narrower than that of RGB.

Yet further, Non-Patent Documents 1 and 2 describe a biometric pattern matching device that operates as below. After extracting ridges from a skin image containing a skin pattern, the biometric pattern matching device detects minutiae, and creates a minutia network based on a relationship between the adjacent minutiae. Then, matching is performed between patterns on the basis of feature amounts including positions and directions of the minutiae, types of ending points, bifurcation points and the like of the minutiae, connection relationship of the minutia network, the number (ridge intersection number) of ridges intersecting an edge (line connecting the minutiae) in the minutiae network and the like. Additionally, as for the structure of the minutia network, a local coordinate system is obtained for each minutia on the basis of the direction of the minutia, and the minutia network is formed by the closest minutiae in the respective quadrants in the local coordinate system.

Yet further, Non-Patent Document 3 describes a method for generating a fingerprint image by separating a fingerprint from a texture in the background by applying signal separation using the independent component analysis.

Yet further, Non-Patent Document 4 describes a method capable of processing, recognizing and apprehending an image in a highly flexible and reliable manner as compared with the conventional Fourier-transformation and the wavelet conversion, by extracting a basis function suitable for the image by extracting features occurring independently of each other from the image using the independent component analysis.

### Related Art Document

### Patent Documents

Patent Document 1: Japanese Patent Application Laid-open No. 2008-20942

Patent Document 2; Japanese Patent Application Laid-open No. 2007-175250

Patent Document 3: Japanese Patent Application Laid-open No. 2007-179434

Patent Document 4: Japanese Patent Application Laid-open No. 2007-323389

Patent Document 5: WO 2005/046248

### Non-Patent Documents

Non-Patent Document 1: “Automated Fingerprint Identification by Minutia-Network Feature-Feature Extraction Processes-” written by Hiroshi Asai and two others, journal of The Institute of Electronics, Information and Communication Engineers D-II, vol. J72-D-II, No. 5, pp. 724-732 (1989.5).

Non-Patent Document 2: “Automated Fingerprint Identification by Minutia-Network Feature-Identification Processes-” written by Hiroshi Asai and two others, journal of The Institute of Electronics, Information and Communication Engineers, D-II, vol. J72-D-II, No. 5, pp. 733-740 (1989.5).

Non-Patent Document 3: Fenglan, Bin Kong, “Independent Component Analysis and Its Application in the Fingerprint Image Preprocessing”, Proceeding of 2004 International Conference on Information Acquisition, pp. 365-368.

Non-Patent Document 4: “Application of independent component analysis method (ICA) to pattern recognition and image process and MATLAB simulation” written by Chen Yen-Wei, published on Oct. 31, 2007 from Triceps, pp. 37-45.

### SUMMARY OF THE INVENTION

However, in the techniques described above, there is room for improvement in the following points. More specifically, since plural types of biometric patterns are captured as different images, a large volume of data has to be transferred from a unit in the image capturing system for capturing images to a unit in the processing system for subjecting the biometric patterns contained in the images to the matching process. For example, in Patent Document 1, Patent Document 2 and Patent Document 3, image data of the fingerprint and the vein are captured by alternatively switching light sources, and hence, the amount of data to be transferred is doubled. Further, in Patent Document 1, it is necessary to obtain and transfer the images in accordance with scanning of the finger, and hence, high-speed data transfer is required. Accordingly, there is a possibility that the resulting increase in the volume of data to be transferred leads to a bottle neck of the process. This causes a serious problem especially in the case of increasing the available speed at which the finger can be scanned or in the case of increasing the resolution of the image data.

The present invention has been made in view of the circumstances described above, and an object of the present invention is to provide a pattern matching device and a pattern matching method capable of obtaining an image containing plural types of biometric patterns, and separating and extracting the plural types of biometric patterns from the image, thereby to implement matching.

A pattern matching device according to the present invention may include: an image obtaining unit that obtains an image of a subject containing a plurality of types of biometric patterns; a separation-and-extraction unit that separates and extracts the plurality of types of biometric patterns from the image; and, a matching unit that matches each of the separated and extracted plurality of types of biometric patterns against biological information for matching registered in advance to derive a plurality of matching results.

Further, a pattern matching method according to the present invention may include: an image obtaining step of obtaining an image of a subject containing a plurality of types of biometric patterns; a separation-and-extraction step of separating and extracting the plurality of types of biometric patterns from the image; and, a matching step of matching each of the separated and extracted plurality of types of biometric patterns against biological information for matching registered in advance to derive a plurality of matching results.

According to the present invention, an image containing plural types of biometric patterns is obtained; plural types of biometric pattern are separated and extracted from the image; and matching is performed on the basis of the separated and extracted plural types of biometric patterns. Therefore, it is possible to reduce an image data transmitted from a unit in an image capturing system to a unit in a process system to a relative low volume.

According to the present invention, it is possible to provide a pattern matching device and a pattern matching method capable of obtaining an image containing plural types of biometric patterns, separating and extracting plural types of biometric patterns from the image, thereby to implement matching.

### BRIEF DESCRIPTION OF THE DRAWINGS

The object described above, other objects, features and advantages of the present invention will be made clear by the following attached drawings, and preferred exemplary embodiments described later.

FIG. 1 is a configuration diagram of a pattern matching device according to an exemplary embodiment of the present invention.

FIG. 2 is a configuration diagram of an image obtaining unit according to a first exemplary embodiment of the present invention.

FIG. 3 is a flowchart of a determination process implemented at the time of obtaining an image according to the first exemplary embodiment of the present invention.

FIG. 4 is a configuration diagram of a matching unit according to the exemplary embodiments of the present invention.

FIG. 5 is a configuration diagram of an image obtaining unit according to a second exemplary embodiment of the present invention.

FIG. 6 is a configuration diagram of an image obtaining unit according to a third exemplary embodiment of the present invention.

FIG. 7 is a flowchart of a pattern matching method according to the exemplary embodiment of the present invention.

### DESCRIPTION OF EMBODIMENTS

Hereinbelow, an exemplary embodiment of the present invention will be described with reference to the drawings. Note that, in all the drawings, the same constituent components are denoted with the same reference numerals, and the explanation thereof will not be repeated.

### First Exemplary Embodiment

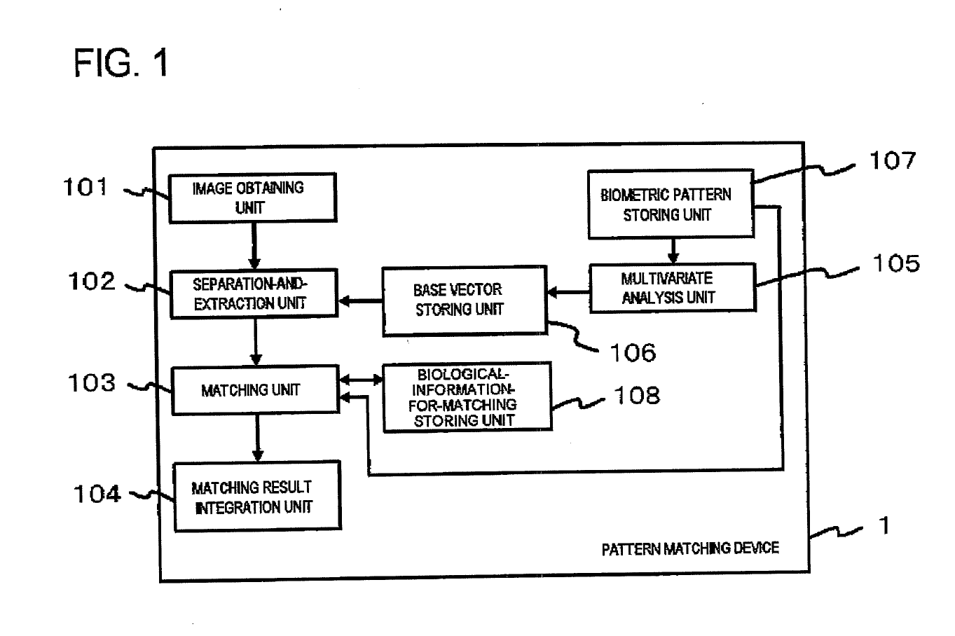

FIG. 1 is a block diagram of a pattern matching device 1 according to the exemplary embodiment of the present invention. The pattern matching device 1 may include an image obtaining unit 101 that obtains an image of a subject containing plural types of biometric patterns; a separation and extraction unit 102 that separates and extracts the respective types of biometric patterns from the image; and, a matching unit 103 that matches each of the separated and extracted plural types of biometric patterns against pre-registered biological information for matching so as to obtain plural matching results. The term “biological information for matching” refers to a biometric pattern (or information representing its feature) registered in advance to be compared and matched with a biometric pattern (or information representing its feature) extracted from an image obtained by the pattern matching device 1.

The pattern matching device 1 may further include a matching result integration unit 104 that integrates the plural matching results. With this unit, the obtained plural matching results are integrated to obtain a final matching result, whereby it is possible to obtain the matching results with higher accuracy. Further, even if the matching of any of the biometric patterns fails, the matching result can be obtained.

In this exemplary embodiment, the subject is a finger; and the biometric pattern includes a fingerprint pattern, which is a fingerprint image of the finger, and a blood vessel pattern, which is a blood vessel image of the finger; and a biometric base vector may include a fingerprint base vector M1 for extracting the fingerprint pattern and a blood vessel base vector M2 for extracting the blood vessel pattern.

Further, the biological information for matching may include a fingerprint pattern for matching, which is used for matching the fingerprint pattern, and a blood vessel pattern for matching, which is used for matching the blood vessel pattern, or the biological information for matching may include fingerprint feature information for matching and blood vessel feature information for matching, which represent features of the fingerprint pattern and the blood vessel pattern, respectively. The pattern matching device 1 may be configured to include a biological-information-for-matching storing unit 108 for storing plural types of biological information for matching, and the matching unit 103 obtains the plural types of biological information for matching from the biological-information-for-matching storing unit 108.

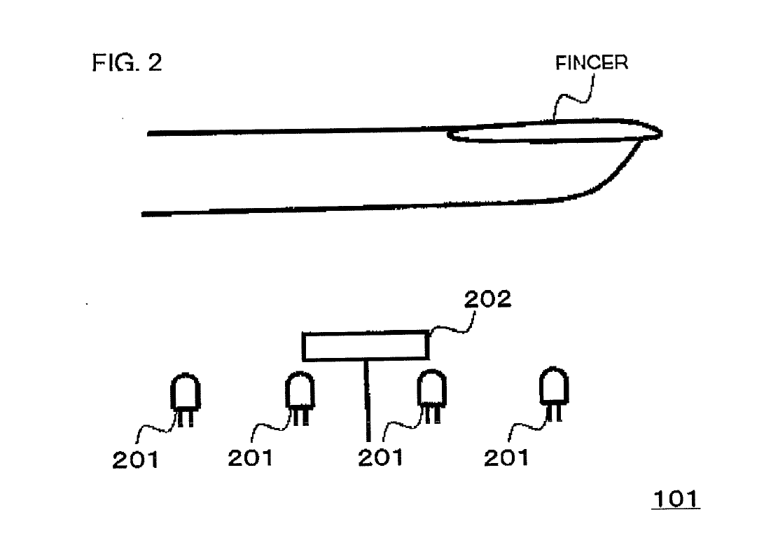

FIG. 2 illustrates a configuration example of the image obtaining unit 101 according to the first exemplary embodiment of the present invention. In FIG. 2, the image obtaining unit 101 according to the first exemplary embodiment may include a white-color light source 201 employing a white-color LED, and an image capturing device 202 capable of capturing color images represented in an RGB colorimetric system. With these units, the image obtaining unit 101 can obtain the color images containing the fingerprint pattern and the blood vessel pattern and having three RGB color components.

As the image capturing device 202, a single plate type camera in which each pixel in an imaging element thereof has s single color filter of RGB (so-called 1CCD camera in the case where the imaging element is a CCD sensor) is employed. Alternatively, it may be possible to employ a three plate type camera in which, by using a dichroic prism, an image is separated into three components of R, G and B, and the image is captured with three imaging elements (so-called 3CCD camera in the case where the imaging element is a CCD sensor). By using the widely used camera as described above, it is possible to employ widely available inexpensive consumer parts, whereby cost reduction of the pattern matching device 1 can be achieved. Note that the white-color light source 201 can be omitted from the image obtaining unit 101 of this exemplary embodiment, in a case where the pattern matching device 1 is limited to be used only under the condition that the solar light, environmental light or the like exists.

Further, it is only necessary that the image obtaining unit 101 of this exemplary embodiment can obtain images, and photographing capability is not required for the image obtaining unit 101 of this exemplary embodiment. For example, it may be possible to obtain, through communication networks and the like, an image photographed, by using a widely spread digital camera, a camera provided to a cell phone and the like.

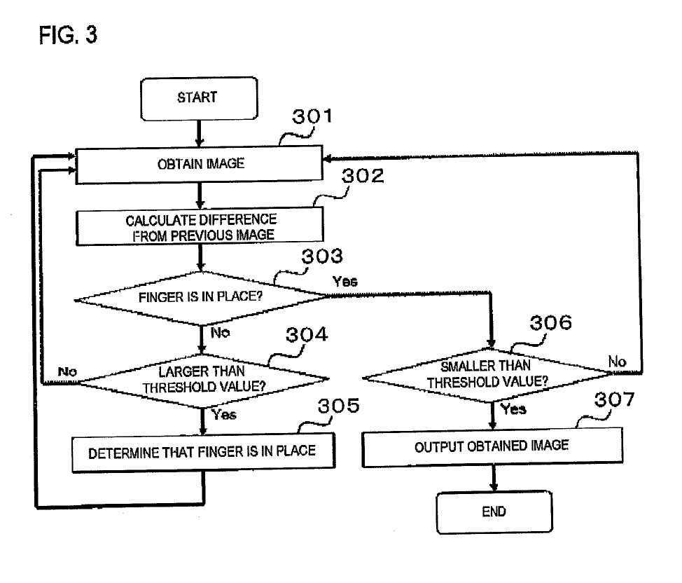

According to the flow illustrated in FIG. 3, determination as to whether the image used for matching is obtained is performed as follows:

First, an image is obtained from the image obtaining unit 101 (step 301). Next, the total of image difference in frames between an image obtained at a previous time and an image obtained at this time is calculated (step S302). Determination is made on the basis of a status flag indicating whether a finger is in place or not. When the finger is not in place (NO in step S303), it is determined whether the total of the difference is larger than a predetermined threshold value or not (step S304). When the total of the difference is larger than the predetermined threshold value (YES in step S304), it is determined that a subject (finger) is in place, and the status flag is updated (step S305). Then, the image is obtained again (step S301), an operation in which difference between the images obtained at the previous time and at this time is calculated is repeated (step S302). The threshold determination with respect to the total of the difference is performed in a state where the finger is in place (YES in step S300). If it is determined to be smaller than the threshold value (YES in step S306), it is determined that the finger is not moved, and the image obtained at that time is outputted as an image for use in matching (step S307). On the other hand, in a case where the result of the threshold determination with respect to the total of the difference indicates to be larger than the threshold value (NO in step 8306), it is determined that the finger is moved, and the process returns to a step of obtaining the image again (step S301). Note that it may be possible to start the procedure above by separately providing a button switch for starting verification and depressing the button, or to start its operation at a time when biometric verification is necessary in the application of an ATM terminal at a bank.

As illustrated in FIG. 1, the pattern matching device 1 may further include: a biometric pattern storing unit 107 that stores biometric patterns; a multivariate analysis unit 105 that calculates biometric base vectors (fingerprint base vector M1 and a blood vessel base vector M2) by subjecting the biometric pattern obtained from a biometric pattern storing unit 107 to a multivariate analysis; and, a base vector storing unit 106 that stores biometric base vectors calculated by the multivariate analysis unit 105. Further, the separation and extraction unit 102 may obtain the biometric base vectors from the base vector storing unit 106.

It should be noted that the biometric patterns stored in the biometric pattern storing unit 107 can be obtained from any source. For example, the biometric patterns may be obtained from an external storing device (not shown) or external network (not shown), each of which is connected with the pattern matching device 1.

As the multivariate analysis, the multivariate analysis unit 105 may implement any of an independent component analysis, principal component analysis, or discriminant analysis. In this exemplary embodiment, description will be made of a case where the multivariate analysis unit 105 implements the independent component analysis.

The independent component analysis is a multivariate analysis method for separating signals for each independent component without using any prerequisite. The image obtained by the image obtaining unit 101 includes the fingerprint pattern and the blood vessel pattern. The blood flowing in the vein contains reduced hemoglobin after oxygen is supplied to the body, the reduced hemoglobin having a feature in which it well absorbs an infrared ray having a wavelength of 760 nm. Therefore, by capturing the images in color, it is possible to make clear the difference in color from the fingerprint pattern whose image is captured by using light reflected on the surface of the finger, so that each of the patterns can be extracted by subjecting the image to the multivariate analysis using the independent component analysis.

In a case where the multivariate analysis is performed using the independent component analysis, the number of images m used for the independent component analysis and the number of signal n to be extracted have to satisfy a relationship of m>=n. Further, all the images used for the independent component analysis have to contain the same independent component to extract the independent components, and hence, simultaneity of the images is important for capturing the images of the fingerprint and the blood vessel. In the first exemplary embodiment of the present invention, since the image obtaining unit obtains a color image represented in the RGB calorimetric system, it is possible to satisfy the above-described relationship of the number of images m and the number of signals n to be separated and extracted, by separating the respective images into three components of R (red), G (green) and (blue) for use in the independent component analysis. Further, since a fingerprint pattern and a blood vessel pattern are extracted from the image containing the fingerprint pattern and the blood vessel pattern, and hence, the simultaneity of both images is acceptable. Below, a method of calculating the fingerprint base vector M1 and the blood vessel base vector M2 using the independent component analysis will be described in detail.

First, the multivariate analysis unit 105 obtains at least one side of the plural fingerprint patterns and the plural blood vessel patterns from the biometric pattern storing unit 107.

The plural fingerprint patterns obtained by the multivariate analysis unit 105 will be denoted by {S1ⁱ (x, y)} (i=1, 2, . . . , N1; N1 represents the number of fingerprint patterns) below. The plural blood vessel patterns obtained by the multivariate analysis unit 105 will be denoted by {S2ⁱ (x, y)} (i=1, 2, . . . , N2; N2 represents the number of blood vessel patterns). Further, the fingerprint patterns S1ⁱ (x, y) and the blood vessel patterns S2ⁱ (x, y) are images formed by three color components of R, G and B, and hence, can be expressed by the following Equation 1.

$$\begin{matrix}[ Equation 1 ] & \\ s {1}^{i} ( x , y ) = ( \begin{matrix}s {1}_{R}^{i} ( x , y ) \\ s {1}_{G}^{i} ( x , y ) \\ s {1}_{B}^{i} ( x , y )\end{matrix} ) \\ s {2}^{i} ( x , y ) = ( \begin{matrix}s {2}_{R}^{i} ( x , y ) \\ s {2}_{G}^{i} ( x , y ) \\ s {2}_{B}^{i} ( x , y )\end{matrix} ) & ( 1 )\end{matrix}$$

These images are subjected to the independent component analysis to calculate the fingerprint base vector M1 and the blood vessel base vector M2. First, description will be made of a case where the fingerprint base vector M1 is calculated. In the independent component analysis, a covariance matrix C concerning all the pixels in the fingerprint patterns is calculated, by using the respective pixels in the fingerprint patterns contained in {S1ⁱ (x, y)} as elements. The covariance matrix C can be expressed by the following Equation 2, where N1ₓ and N1_{y} are image sizes of the finger print patterns.

$$\begin{matrix}[ Equation 2 ] & \\ C = \frac{1}{N 1 \cdot N {1}_{x} \cdot N {1}_{y}} {\sum }_{i = 1}^{N 1} {\sum }_{( x , y )} ( \begin{matrix}s {1}_{R}^{i} ( x , y ) \\ s {1}_{G}^{i} ( x , y ) \\ s {1}_{B}^{i} ( x , y )\end{matrix} ) \\ ( \begin{matrix}s {1}_{R}^{i} ( x , y ) & s {1}_{G}^{i} ( x , y ) & s {1}_{B}^{i} ( x , y )\end{matrix} ) & ( 2 )\end{matrix}$$

Next, a matrix T for decorrelation (whitening) can be calculated by the following Equation 3 using the covariance matrix C.

[Equation 3]

T=^{t}EΛ^{-1/2}E (3)

In this equation, E is an orthonormal matrix of 3×3 formed by eigenvector of the covariance matrix C, and Λ (lambda) is a diagonal matrix having its eigenvalue in the diagonal component. Further, ^{t}E is a transposed matrix of E.

Next, for each pixel in the fingerprint pattern, a decorrelated image u1ⁱ (x, y) is obtained by applying the matrix T as expressed in Equation 4.

$$\begin{matrix}[ Equation 4 ] & \\ u {1}^{i} ( x , y ) = ( \begin{matrix}u {1}_{1}^{i} ( x , y ) \\ u {1}_{2}^{i} ( x , y ) \\ u {1}_{3}^{i} ( x , y )\end{matrix} ) = {}^{i} Ts {1}^{i} ( x , y ) = {}^{i} T ( \begin{matrix}s {1}_{R}^{i} ( x , y ) \\ s {1}_{G}^{i} ( x , y ) \\ s {1}_{B}^{i} ( x , y )\end{matrix} ) & ( 4 )\end{matrix}$$

Next, by using the image u1ⁱ (x, y) to which the matrix T for decorrelation has been applied, the separation matrix W (=(w₁ w₂ w₃)^{t}) of 3×3 for obtaining the independent component is calculated. First, a given initial value Wo of W is determined. By using the Wo as the initial value, the separation matrix W is calculated by using the updating rule described in the Non-Patent Document 4. Through the processes described above, the separation matrix W of 3×3 for obtaining the independent component can be obtained.

Of the three components obtained by using the separation matrix W, in order to specify a component corresponding to the fingerprint pattern, a linear transformation is applied to the image S1ⁱ (x, y) of the fingerprint by using the separation matrix W as expressed by Equation 5.

$$\begin{matrix}[ Equation 5 ] & \\ v {1}^{i} ( x , y ) = ( \begin{matrix}v {1}_{1}^{i} ( x , y ) \\ v {1}_{2}^{i} ( x , y ) \\ v {1}_{3}^{i} ( x , y )\end{matrix} ) = {}^{i} Wu {1}^{i} ( x , y ) = {}^{i} W {}^{i} Ts {1}^{i} ( x , y ) & ( 5 )\end{matrix}$$

Of the three images of v1ⁱ₁ (x, y), v1ⁱ₂ (x, y) and v1ⁱ₃ (x, y) obtained for the image S1ⁱ (x, y), the image having the most emphasized fingerprint pattern is visually determined, and, a base vector w_{f} corresponding to the determined image in the separation matrix is selected as the component corresponding to the fingerprint pattern. The reason for making this visual determination is that, because of application of the decorrelation, it is not known which component corresponds to the fingerprint pattern, and thus, visual determination is added for the purpose of checking. As the fingerprint base vector M1 stored in the base vector storing unit 106, a vector obtained from the following Equation 6 is stored as the fingerprint base vector M1 in consideration of decorrelation.

[Equation 6]

M1=^{t}w_{f}^{t}T (6)

Further, similar to the case described above, the blood vessel base vector M2 is calculated, and is stored in the base vector storing unit 106.

These are descriptions of the method of calculating the fingerprint base vector M1 and the blood vessel base vector M2 by using the independent component analysis. However, the fingerprint base vector M1 and the blood vessel base vector M2 may be calculated by using the principal component analysis, or discriminant analysis.

For example, in the case of using the principal component analysis, the fingerprint patterns contained in the {S1ⁱ (x, y)} are subjected to eigenvalue-decomposition by using the covariance matrix C obtained through Equation 4 to obtain, as the fingerprint base vector M1, the eigenvector with the largest eigenvalue (vector corresponding to the first principal component). Similarly, the blood vessel patterns contained in the {S2ⁱ (x, y)} are subjected to eigenvalue-decomposition by using the covariance matrix C to obtain the blood vessel base vector M2. The principal component analysis is a method for realizing the dimension-lowering of data while minimizing the amount of information loss.

In the case of using the discriminant analysis, it may be possible to apply the discriminant analysis as described below. Determination is made as to whether each pixel in the fingerprint patterns contained in the {S1ⁱ (x, y)} corresponds to a ridge of the fingerprint or to a valley between ridges. The pixel corresponding to the ridge is set to be a pixel belonging to a category of ridge C_{Ridge}, and the pixel corresponding to the valley is set to be a pixel belonging to a category of valley C_{Valley}. Regarding the two categories, the covariance matrix in the respective categories and the covariance matrix between the categories are obtained, and the obtained covariance matrices are subjected to the discriminant analysis, whereby vectors enhancing the ridge and the valley are calculated. Then, the calculated vectors are stored in the base vector storing unit 106 as the fingerprint base vector M1. Similarly, the blood vessel base vector M2 can be obtained by determining whether each pixel in the blood vessel patterns contained in the {S2ⁱ (x, y)} corresponds to a blood vessel portion or not; separating the determination results into categories in advance for each pixel; and, applying the discriminant analysis. Although categorizing operation is required, it is possible to enhance the ridge image and the blood vessel image more effectively by using the discriminant analysis.

The separation and extraction unit 102 receives a color image obtained through the image obtaining unit 101 as an input image, and performs linear transformation to each pixel in an input image by using the fingerprint base vector M1 for extracting the fingerprint pattern and the blood vessel base vector M2 for extracting the blood vessel pattern stored in the base vector storing unit 106, thereby to calculate and output a fingerprint pattern image g1 (x, y) and a blood vessel pattern image g2 (x, y). More specifically, by denoting the input image by f_{color} (x, y), the color image can be expressed by the vector as described in the following Equation 7 using f_{R} (x, y), f_{G} (x, y) and f_{B} (x, y), each of which represents a density value of each of the three color components of RGB.

$$\begin{matrix}[ Equation 7 ] & \\ {f}_{color} ( x , y ) = ( \begin{matrix}{f}_{R} ( x , y ) \\ {f}_{G} ( x , y ) \\ {f}_{B} ( x , y )\end{matrix} ) & ( 7 )\end{matrix}$$

As expressed in Equation 7, each pixel of the image is expressed by an image vector including the density value of each of plural color components (R, G and B in this exemplary embodiment) as an element. The separation and extraction unit 102 may separate and extract the biometric pattern from the image, by obtaining a biometric base vector corresponding to any of plural types of biometric patterns and calculating the value obtained by the inner product of the biometric base vector and the image vector as the density value of the biometric pattern. More specifically, the density value g1 (x, y) of the fingerprint pattern at a coordinate (x, y) can be expressed by the inner product of the fingerprint base vector M1 and the vector of the above-described Equation 7. Further, the density value g2 (x, y) of the blood vessel pattern at a coordinate (x, y) can be expressed by the inner product of the blood vessel base vector M2 and the vector of the above-described Equation 7. The following Equation 8 express the density values described above.

$$\begin{matrix}[ Equation 8 ] & \\ \begin{matrix}g 1 ( x , y ) = {}^{i} M 1 {f}_{color} ( x , y ) \\ = ( \begin{matrix}m {1}_{R} ( x , y ) & m {1}_{G} ( x , y ) & m {1}_{B} ( x , y )\end{matrix} ) ( \begin{matrix}{f}_{R} ( x , y ) \\ {f}_{G} ( x , y ) \\ {f}_{B} ( x , y )\end{matrix} )\end{matrix} & ( 8 ) \\ \begin{matrix}g 2 ( x , y ) = {}^{i} M 2 {f}_{color} ( x , y ) \\ = ( \begin{matrix}m {2}_{R} ( x , y ) & m {2}_{G} ( x , y ) & m {2}_{B} ( x , y )\end{matrix} ) ( \begin{matrix}{f}_{R} ( x , y ) \\ {f}_{G} ( x , y ) \\ {f}_{B} ( x , y )\end{matrix} )\end{matrix} & \end{matrix}$$

As expressed by Equation 8 above, the density value of the fingerprint pattern and the density value of the blood vessel pattern extracted by the separation and extraction unit 102 according to this exemplary embodiment are scalars. More specifically, both the extracted fingerprint pattern and the blood vessel pattern are images formed by one single color component, and the density value of each pixel in the images can be expressed by one single element.

Further, the amount of calculation performed by the separation and extraction unit 102 is in proportion to the number of pixels. Thus, assuming that each of the images has a square shape and N is a length of each side of the square, the amount of calculation that the separation and extraction unit 102 performs varies in proportion to N².

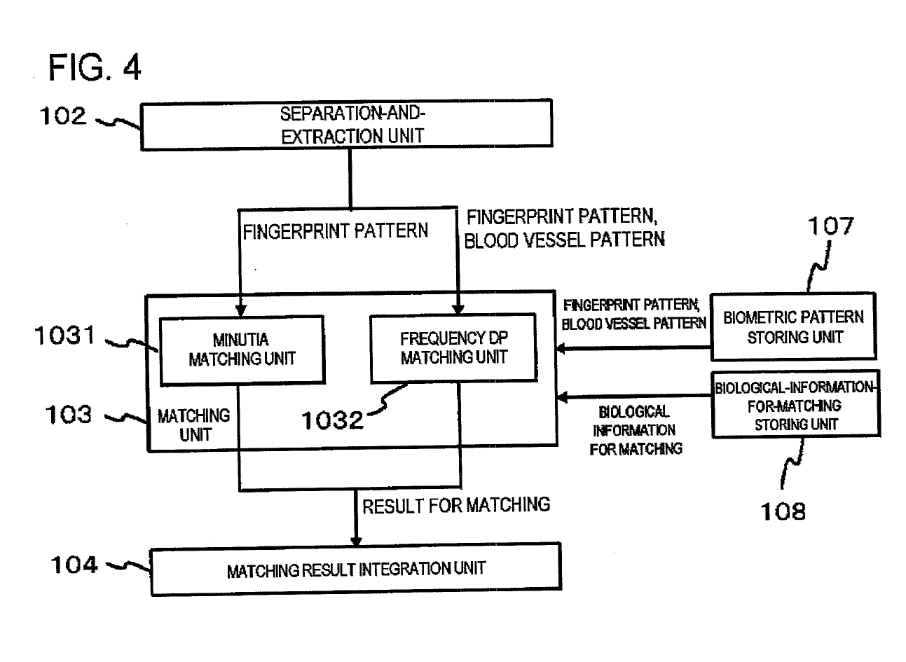

FIG. 4 illustrates a configuration of the matching unit 103 according to the first exemplary embodiment of the present invention. The matching unit 103 obtains the fingerprint pattern and the blood vessel pattern obtained by the separation and extraction unit 102, and matches the obtained fingerprint pattern and blood vessel pattern against the pre-registered plural types of biological information for matching to derive plural matching results. Here, the matching unit 103 may include a minutia matching unit 1031 that: extracts feature points formed by ridges of the fingerprint, and bifurcation points and ending points of the ridges from the fingerprint patterns; and calculates similarities on the basis of the feature points, thereby to obtain the similarities as the matching results. Further, the matching unit 103 may include a frequency DP matching unit 1032 that: calculates, as a feature amount, a Fourier amplitude spectrum obtained by subjecting at least one of the fingerprint pattern and the blood vessel pattern to one-dimensional Fourier transform; extracts a principal component of the feature amount using the principal component analysis; calculates a similarity through DP matching on the basis of the principal component of the feature amount, thereby to obtain the similarity as the matching results.

Below, description will be made of matching of the fingerprint pattern made by the minutia matching unit 1031 in the matching unit 103.

The minutia matching unit 1031 calculates the matching results using a minutia matching method. The minutia matching method is a method of performing the matching using the feature points formed by ridges of the fingerprint, and bifurcation points and ending points of the ridges. The feature points are called minutiae. The number of ridges that intersect a line connecting the closest minutiae is called relation, which is used at the time of matching operation for the network and relation in terms of minutiae.

First, smoothing and image enhancement are performed to remove quantization noises from the fingerprint pattern obtained from the separation and extraction unit 102 and the fingerprint pattern for matching obtained from the biological-information-for-matching storing unit 108. Next, a ridge direction is obtained within a local area of 31×31 pixel. Accumulated values of density variation in eight quantization directions in the local area are calculated. On the basis of the thus obtained accumulated values, classification into “blank,” “no direction,” “weak direction” and “strong direction” is made in accordance with classification rules and threshold values. Further, the smoothing process is performed by applying the weighted majority in the 5×5 neighboring area adjacent to each of the areas. At this time, if a different direction exists, classification into “different direction area” is performed.

Next, the ridges are extracted. Filters created by using the ridge direction are applied to the original image to obtain a binary image on the ridges. A micro-noises removal process and a thinning process using eight-neighbor pixels are applied to the obtained binary image.

From the binary center line image of the ridges obtained through the processes above, the feature points are extracted by using a binary detection mask of 3×3. Determination is made of whether the target local area is clear area or unclear area on the basis of the obtained number of feature points, the number of center line pixel and classification of local areas. Only the clear area is used for the matching.

Directions of feature points are determined on the basis of target feature points and a center line of a ridge adjacent to the target feature points. A rectangular coordinate system is set by defining the thus obtained direction as y axis, and the closest feature points are selected in each quadrant in the rectangular coordinate system. The number of center lines of ridges intersecting a line connecting each of the closest feature point and the target feature point is obtained. In this exemplary embodiment, the maximum number of the center lines of the ridges intersecting the line is 7.

The feature amount can be obtained through the processes described above. Below, the matching process using the obtained feature amount will be described.

Even in a case of the same fingerprint, the minutia network may vary due to deformation of a finger at the time of fingerprinting or extraction process of the feature points. To deal with this, the target feature point is obtained as a parent feature point, a feature point located closest to the parent feature point is obtained as a child feature point, and a child feature point of the child feature point is obtained as a grandchild feature point. The distortion of the minutia network is corrected on the basis of the positional relationship between the three feature points.

Next, the candidate pair of the feature point of the fingerprint pattern and the feature point of the fingerprint pattern for matching are obtained. First, if the distance and the direction between both the parent feature points are sufficiently matched, such feature points are set as the candidate pair. If this matching relationship is not sufficiently established, comparison is made by using the child feature points and the grandchild feature points to obtain conformity between the feature points as a pairing strength. On the basis of the obtained pairing strength, a list of the candidate pairs is obtained. Then, position matching is performed for each of the candidate pairs by a moving average method and rotation.

From among the candidate pairs to which the position matching has been performed, candidate pairs are further selected by using a threshold value. If a candidate pair satisfies the threshold value with each other, such a pair is set as a basic pair, and feature points thereof are removed from a list of the other candidate, thereby determining the feature points to be paired.

The similarity S between the fingerprint pattern and the fingerprint pattern for matching is obtained from the following Equation 9 on the basis of the pairing strength wₛ of the feature points and the number of feature points Nₛ of the fingerprint pattern, and the pairing strength w_{f} of the feature points and the number of feature points N_{f} of the fingerprint pattern for matching.

$$\begin{matrix}[ Equation 9 ] & \\ S = \frac{{\sum }_{s = 1}^{{N}_{s}} {w}_{s} \times {\sum }_{f = 1}^{{N}_{f}} {w}_{f}}{{N}_{s} \times {N}_{f}} & ( 9 )\end{matrix}$$

The minutia matching unit 1031 derives the similarity S as the matching result of the fingerprint matching. Note that description has been made of the configuration in which the minutia matching unit 1031 processes the fingerprint patterns obtained from the separation and extraction unit 102 and the fingerprint patterns for matching obtained from the biological-information-for-matching storing unit 108 in parallel. However, it may be possible to employ a configuration in which: information representing features of the fingerprint pattern for matching such as feature points and feature amount, that is, fingerprint feature information for matching is extracted in advance; the extracted information is stored in the biological-information-for-matching storing unit 108; and, the stored information is read out from the biological-information-for-matching storing unit 108 when needed.

Further, the minutia matching unit 1031 may have a configuration in which virtual minutia representing sampling points of feature amount concerning a fingerprint pattern formed by ridges and valleys of a fingerprint is added to an area on the pattern where no actual minutia exists. Further, it may be possible to employ a configuration in which information concerning a feature amount of a fingerprint impression area is extracted from the virtual minutia, and the virtual minutia is also used as a matching point. This makes it possible to increase the number of feature points themselves used for the fingerprint pattern matching. Further, information on the ridges and valleys is broadly extracted from the fingerprint pattern and is used for matching, whereby it is possible to obtain the matching results (similarity) with high accuracy.

Next, description will be made of matching of a blood vessel pattern by the frequency DP matching unit 1032 contained in the matching unit 103.

First, the frequency DP matching unit 1032 subjects a blood vessel pattern obtained from the separation and extraction unit 102 and a blood vessel pattern for matching obtained from the biological-information-for-matching storing unit 108 to a one-dimensional discrete Fourier transform in terms of a line oriented in a horizontal direction or a line oriented in a vertical direction to calculate the thus obtain Fourier amplitude spectrum. Thereafter, a feature amount effective for discrimination is extracted, by removing a direct-current component, which will be unnecessary at the time of discrimination, and a symmetrical component of the Fourier amplitude spectrum in consideration of the Fourier amplitude spectrum being symmetry.

Next, a basis matrix is calculated by using the principal component analysis for the blood vessel pattern obtained from the biometric pattern storing unit 107. A feature amount extracted by using the basis matrix is subjected to a linear transformation to extract the principal component of the feature amount. By using a DP matching method for the principal component of the extracted feature amount, matching is performed, considering positional displacement and distortion only in one direction. In the DP matching, a DP matching distance represents the similarity between the two feature amounts at the time when the distance between two feature amounts is the minimum value. More specifically, the shorter the distance is, the higher the similarity is. In this exemplary embodiment, the inverse of the distance value of this DP matching is the similarity, and this similarity is derived as the matching result. In this exemplary embodiment, the method described above is referred to as the frequency DP matching method.

It should be noted that the frequency DP matching unit 1032 can perform a matching to the fingerprint pattern, as is the case with the matching to the blood vessel pattern. In this case, the frequency DP matching unit 1032 extracts the feature amount from each of the fingerprint pattern obtained from the separation and extraction unit 102 and the fingerprint pattern for matching obtained from the biological-information-for-matching storing unit 108. Next, a basis matrix is calculated by using the principal component analysis for the fingerprint pattern obtained from the biometric pattern storing unit 107. A feature amount extracted by using the basis matrix is subjected to a linear transformation to extract the principal component of the feature amount. By using a DP matching method for the principal component of the extracted feature amount, matching is performed, considering positional displacement and distortion only in one direction.

Further, description has been made of the configuration in which the frequency DP matching unit 1032 processes the blood vessel pattern and the fingerprint pattern obtained from the separation and extraction unit 102 and the blood vessel pattern for matching and the fingerprint pattern for matching obtained from the biological-information-for-matching storing unit 108 in parallel. However, it may be possible to employ a configuration in which: information representing features of the blood vessel pattern for matching such as a feature amount, that is, the blood vessel feature information for matching and the fingerprint feature information for matching are extracted in advance; the extracted information is stored in the biological-information-for-matching storing unit 108; and, the stored information is read out from biological-information-for-matching storing unit 108 when needed.

Further, the frequency DP matching unit 1032 may calculate the similarity by projecting a biometric pattern or the feature amount obtained from the biometric pattern to perform dimensional compression; back-projecting the thus obtained feature data using a predetermined parameter; re-configuring a feature expression in a space corresponding to the biometric pattern or the feature amount obtained from the biometric pattern; and., performing comparison calculation of the feature expression in the space. This makes it possible to reduce the data size of the feature amount, and calculate the matching result (similarity) with high accuracy.

The matching result integration unit 104 integrates the matching result concerning the fingerprint pattern and the matching result concerning the blood vessel pattern obtained from the matching unit 103. At this time, the matching result integration unit 104 may multiply each of the similarities obtained as plural matching results by a predetermined weighting coefficient, and combine them.

In a case where the matching result integration unit 104 integrates a matching result D_{fing} of the fingerprint pattern obtained as a result of the matching by either the minutia matching unit 1031 or the frequency DP matching unit 1032 and a matching result Dᵥₑᵢₙ of the blood vessel pattern obtained as a result of the matching by the frequency DP matching unit 1032, an integrated matching result Dₘᵤₗₜᵢ can be calculated by the following Equation 10.

[Equation 10]

Dₘᵤₗₜᵢ=D_{fing}×cos θ+Dᵥₑᵢₙ×sin θ (10)

In this equation, θ is a parameter for determining the weighting for values of D_{fing} and Dᵥₑᵢₙ, and is experimentally obtained in advance.

Further, as described above, the matching unit 103 can perform the matching to the fingerprint pattern by the minutia matching unit 1031, and perform the matching to the fingerprint pattern and the blood vessel pattern by the frequency DP matching unit 1032. In this case, two matching results can be obtained for the fingerprint pattern, and hence, the integrated matching result Dₘᵤₗₜᵢ can be calculated by the following Equation 11.

[Equation 11]

Dₘᵤₗₜᵢ=(D_{fing1}×sin η+D_{fing2}×cos η)×sin θ+Dᵥₑᵢₙ×cos θ (11)

In Equation 11, D_{fing1} and D_{fing2} represent a matching result of the matching concerning the fingerprint pattern by the minutia matching unit 1031, and a matching result of the matching concerning the fingerprint pattern by the frequency DP matching unit 1032, respectively. Dᵥₑᵢₙ is a matching result of the matching concerning the blood vessel pattern by the frequency DP matching unit 1032. Further, θ and η are parameters for determining weighting for values of the matching results of D_{fing1}, D_{fing2} and Dᵥₑᵢₙ, and are experimentally obtained in advance.

The more the types of the matching results that the matching result integration unit 104 integrates increase, the more the integrated matching results becomes accurate, and hence, application of Equation 11 described above can produce more accurate integrated matching results as compared with application of Equation 10 described above.

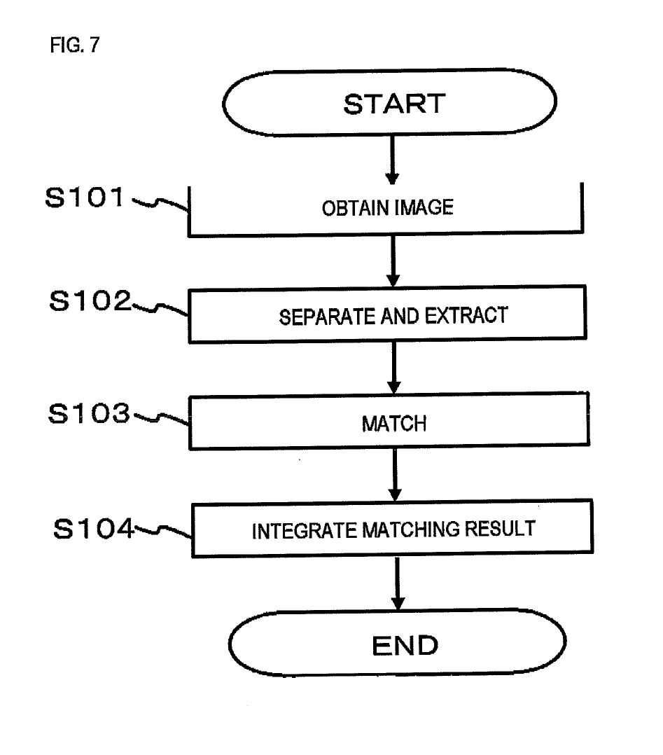

FIG. 7 is a flowchart of a pattern matching method according to this exemplary embodiment. The pattern matching method according to this exemplary embodiment may include an image obtaining step of obtaining an image of a subject containing plural types of biometric patterns (step S101), a separation-and-extraction step of separating and extracting the respective types of the biometric patterns from the obtained image (step S102), and a matching step of matching each of the separated and extracted plural types of biometric patterns against pre-registered biological information for matching to derive plural matching results (step S103).

The pattern matching method according to this exemplary embodiment may further include a matching result integration step of integrating the plural matching results (step S104).

It should be noted that, in this exemplary embodiment, the image obtaining step (step S101), the extraction step (step S102), the matching step (step S103) and the matching result integration step (step S104) are steps performed by the image obtaining unit 101, the separation-and-extraction unit 102, the matching unit 103 and the matching result integration unit 104, respectively. More specifically, each pixel in an image can be expressed by an image vector including a density value of each of plural color components contained in the image as an element, and, the separation-and-extraction step (step S102) may separate and extract the biometric pattern from the image by obtaining a biometric base vector corresponding to any of plural types of biometric patterns; taking an inner product of the biometric base vector and the image vector; and, calculating the value by the inner product as the density value of the biometric pattern.

Further, the matching step (step S103) may employ a minutia matching method in which feature points formed by ridges of the fingerprint and bifurcation points and ending points of the ridges are extracted from the fingerprint pattern, and similarity is calculated on the basis of the feature points, thereby to obtain the similarity as the matching result.

Yet further, the matching step (step S103) may employ a frequency DP matching method in which at least one of the fingerprint pattern and the blood vessel pattern is subjected to a one-dimensional Fourier transform; the thus obtained Fourier amplitude spectrum is calculated as a feature amount; a principal component of the feature amount is extracted by using the principal component analysis; the similarity is calculated by using the DP matching on the basis of the principal component of the feature amount, thereby to obtain the similarity as the matching result.

Further, the matching result integration step (step S104) may multiply each of the matching results derived by the matching unit 103 by a predetermined weighting coefficient, and combine them.

It should be noted that the matching step (step S103) may perform the matching to a fingerprint pattern by using the minutia matching method, and then perform the matching to the fingerprint pattern and a blood vessel pattern by using the frequency DP matching method. This further increases the number of matching results to be integrated in the matching result integration step, whereby it is possible to obtain further accurate integrated matching results.

### Second Exemplary Embodiment

A second exemplary embodiment according to the present invention will be described. In this exemplary embodiment, an image obtained by the image obtaining unit 101 is a multispectral image formed by at least four color components, and, pixels of a biometric pattern extracted by the separation-and-extraction unit 102 may be expressed by the inner product of the biometric base vector and the image vector in at least four or more dimension. However, the number of color components contained in the image obtained by the image obtaining unit 101 is equal to the number of color components of the image stored in the biometric pattern storing unit 107, and the dimension of the biometric base vector is equal to that of the image vector.

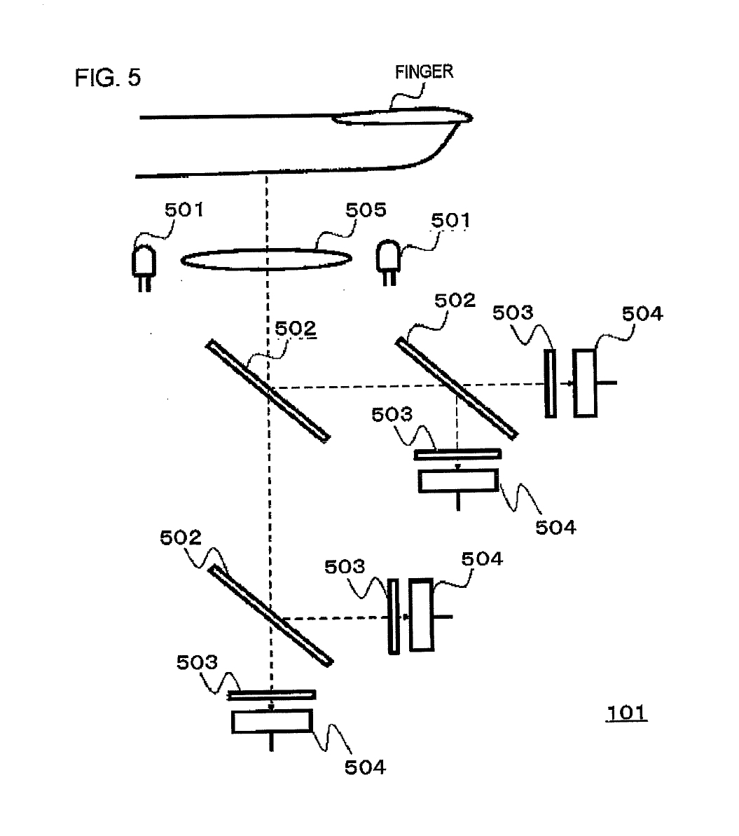

FIG. 5 illustrates an example of the image obtaining unit 101 capable of obtaining the multispectral image. The image obtaining unit 101 may include: plural half-mirrors 502 that separates an optical path of a light emitted through an imaging lens 505 into at least four paths; bandpass filters 503 that each allows a light having a wavelength band different from each other for each of the optical paths separated by the plural half-mirrors 502 to pass through; and imaging devices 504 that each receive the light passing through each of the bandpass filters 503 and capture a multispectral image. Further, a finger of the subject is illuminated by a white-colored light source 501. Note that short-dashed lines in FIG. 5 indicate optical paths of lights reflected by the finger of the subject and reaching the imaging devices 504.

The half-mirror 502 has features of both reflecting and transmitting the light at the same time, and can split the light into two optical paths. As illustrated in FIG. 5, in this exemplary embodiment, the optical path of the light through the imaging lens 505 is separated into four paths by using three half-mirrors. The light can be separated into more than four optical paths by varying the number of or arrangement position of the half-mirrors 502.

The bandpass filter 503 can transmit a specific wavelength in the irradiation light. In order to obtain images captured with plural types of wavelength bands, the respective arranged bandpass filters pass through lights with wavelengths different from each other. This exemplary embodiment employs three bandpass filters 503 having central wavelengths of 420 nm, 580 nm and 760 nm, which correspond to absorption peaks of oxygenated hemoglobin, and a bandpass filter 503 having a central wavelength of 700 nm, which wavelength is less absorbed by the blood vessel. This reduces the effect of absorption of the lights by the blood vessel or oxygenated hemoglobin, whereby a blood vessel pattern of a relatively large blood vessel such as a vein can be favorably obtained. Further, at the time of imaging, a valley portion of the fingerprint is darkly stressed. This is because, by comparing a ridge portion with a valley portion, a surface skin of the valley portion is thinner than that of the ridge portion, and the light is largely absorbed by the blood flowing in the blood capillary below the surface skin of the valley portion.

It should be noted that, in place of the white-colored light source 501, it may be possible to employ LEDs having the above-described wavelengths, or having four wavelengths close to the wavelengths as the light source, and employ bandpass filters having transmissive features corresponding to the four light sources with the above-described wavelengths. By using the LEDs, it is possible to reduce the amount of heat generation, and make control of turning on/off of the light source easier, as compared with the white-colored light source 501 that outputs continuous wavelength.

The imaging devices 509 are arranged such that all lengths of the optical paths indicated by the short-dashed lines in FIG. 5 are equal. With this arrangement, timings at which the respective imaging devices 504 receive the lights are the same, and hence, it is possible to capture the images at the same time. By integrating four images having different color components obtained as described above, the image obtaining unit 101 can obtain a multispectral image formed by four different color components.

The process of the separation-and-extraction unit 102 in this exemplary embodiment is the same as that in the first exemplary embodiment. However, the biometric patterns stored in the biometric pattern storing unit 107 are multispectral images formed by four different color components, and the fingerprint base vector M1 and the blood vessel base vector M2 calculated by the multivariate analysis unit 105 may be four-dimensional vectors. Further, pixels of the fingerprint patterns (or blood vessel patterns) separated and extracted by the separation-and-extraction unit 102 may be expressed by an inner product of the image vector expressing the pixel of the multispectral image obtained by the image obtaining unit 101 and the fingerprint base vector M1 (or blood vessel base vector M2), that is, inner product of the four-dimensional vector.

Further, the processes of the matching unit 103 and the matching result integration unit 104 in this exemplary embodiment are the same as those in the first exemplary embodiment.

In this exemplary embodiment, the image obtaining unit 101 obtains the multispectral image, and hence, a further large number of lights having the wavelength suitable for separation and extraction is selected. This improves the accuracy in extraction of the fingerprint pattern and the blood vessel pattern by the separation-and-extraction unit 102.

### Third Exemplary Embodiment

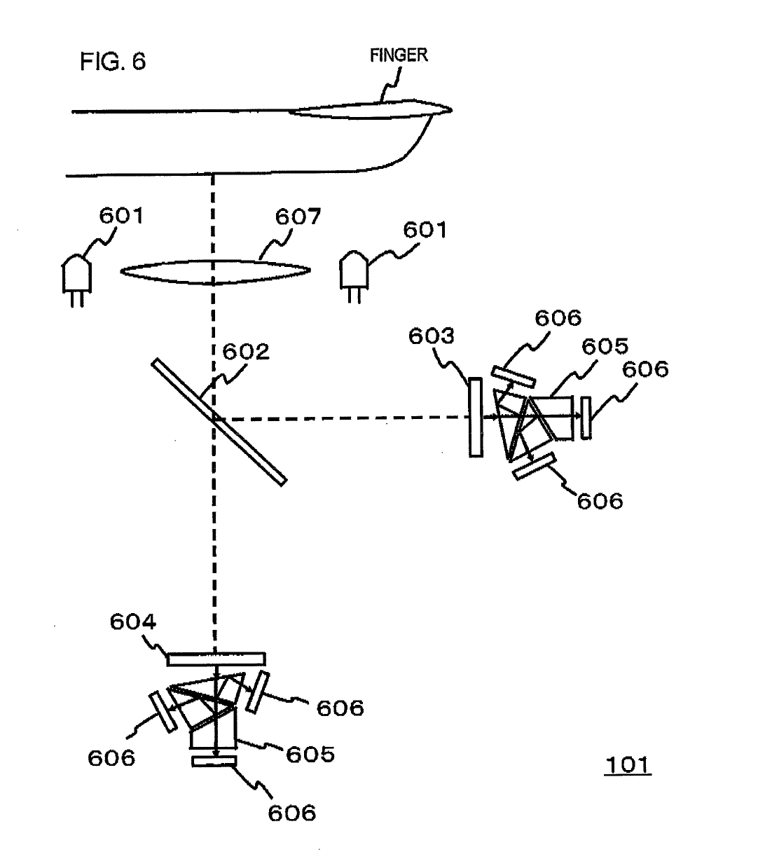

A third exemplary embodiment of the present invention is modified so as to be able to obtain a multispectral image by a configuration different from that in the second exemplary embodiment. A configuration of the image obtaining unit 101 according to this exemplary embodiment is illustrated in FIG. 6. The image obtaining unit 101 may include: a half-mirror 602 that separates an optical path of a light through a imaging lens 607 into at least two paths; an infrared ray cutting filter 603 that blocks an infrared ray contained in a light of one optical path of the at least two optical paths separated by the half-mirror 602 to pass through; a bandpass filter 604 that allows almost a half wavelength band of each of red, green and blue wavelength bands contained in the light of the other optical path of the at least two optical paths separated by the half-mirror 602; a dichroic prisms 605 that each separate the light passing through the infrared ray cutting filter 603 and the light passing through the bandpass filter 604 into the red, green and blue wavelength bands; and, imaging devices 606 that each receive the light separated by the dichroic prisms 605 and capture a multispectral image. Further, a finger of the subject is illuminated by a white-color light source 601. Note that short-dashed lines in FIG. 6 indicate optical paths of lights reflected by the finger of the subject and reaching the imaging devices 606.

Similar to the half-mirror 502 in the second exemplary embodiment, the half-mirror 602 has features of both reflecting and transmitting the light at the same time, and can split the light into two optical paths. Further, the infrared ray cutting filter 603 can block the infrared ray. With this infrared ray cutting filter 603, it is possible to block a light having a wavelength band longer than the visible light from a light of one optical path of the optical paths separated by the half-mirror 602. The light passing through the infrared light cutting filter 603 reaches the dichroic prism 605, and is separated into lights having three wavelength bands of RGB, and an image thereof is captured by each of the imaging devices 606.

Further, the light of the other optical path among the optical paths separated by the half-mirror 602 passes through the bandpass filter 604 having a feature that allows a light having almost a half wavelength band of each RGB wavelength bands to pass through. The light passing through the bandpass filter 604 reaches the dichroic prism 605, and is separated into three wavelength bands of RGB. The imaging device 606 receives the light separated by the dichroic prism 605, and captures a multispectral image. With the configuration described above, the multispectral image formed by six color components can be obtained. At the time of configuring the image obtaining unit 101 according to this exemplary embodiment, the multispectral image formed by six color components can be obtained at the same time by arranging such that all lengths of the optical paths from the imaging lens 607 to the imaging device 606 are equal.

In this exemplary embodiment, the process of the separation-and-extraction unit 102 is the same as that in the first exemplary embodiment or the second exemplary embodiment of the present invention. However, the biometric patterns stored in the biometric pattern storing unit 107 are multispectral images formed by six different color components, and the fingerprint base vector M1 and the blood vessel base vector M2 calculated by the multivariate analysis unit 105 may be six-dimensional vectors. Further, pixels of the fingerprint patterns (or blood vessel patterns) separated and extracted by the separation-and-extraction unit 102 may be expressed by an inner product of the image vector expressing the pixel of the multispectral image obtained by the image obtaining unit 101 and the fingerprint base vector M1 (or blood vessel base vector M2), that is, inner product of the six-dimensional vector.

Further, the processes of the matching unit 103 and the matching result integration unit 104 in this exemplary embodiment are the same as those in the first exemplary embodiment or the second exemplary embodiment of the present invention.

In the third exemplary embodiment of the present invention, by using the multispectral image obtained through the half-mirror 602 and the dichroic prism 605, it is possible to obtain the multispectral image formed by six color components. This makes it possible to select further large number of lights having the suitable wavelength as compared with the second exemplary embodiment according to the present invention, which improves accuracy of extraction of the fingerprint pattern and the blood vessel pattern.

These are descriptions of the exemplary embodiments according to the present invention with reference to the drawings. However, the present invention is not limited to the exemplary embodiments described above. Within the scope of the present invention, various modifications can be made to the configurations and details of the present invention to the extent that the skilled person can understand.

For example, in FIG. 1, the pattern matching device 1 is configured to include the multivariate analysis unit 105, the base vector storing unit 106, the biometric pattern storing unit 107 and the biological-information-for-matching storing unit 108, but the pattern matching device 1 does not necessarily include all these units. The separation-and-extraction unit 102 and the matching unit 103 may be configured so as to obtain a necessary image or parameter from an external device or external system having the equal functions to the units described above.

Further, in FIG. 1, the pattern matching device 1 includes the matching result integration unit 104. However, the pattern matching device 1 does not necessarily include this unit. More specifically, plural matching results derived by the matching unit 103 may be outputted separately.

Further, by modifying the image obtaining unit 101 in FIG. 2 so as to have the configuration as described below, the biometric pattern may be obtained by the image obtaining unit 101. A polarizing filter (not shown) is disposed before the white-colored light source 201 and the imaging device 202, and, a polarization direction of the polarization filter is adjusted such that the fingerprint pattern is most emphasized at the time of capturing the image of the fingerprint pattern, thereby to capture the RGB color image. Similarly, by adjusting the polarization direction of the polarization filter, the RGB color image is captured such that the blood vessel pattern is most emphasized. With this polarizing filter, it is possible to capture images so as to emphasize the fingerprint pattern having increased reflection effect mainly by a total reflection component, and the blood vessel pattern observed through dispersion and reflection influenced mainly from the inside of the body, without modulating color components.

It should be noted that it is possible to apply the present invention to an authentication system for authenticating the user in a system requiring a security in which a user is needed to be identified. For example, it is possible to apply the present invention to a system for authenticating an individual at the time of the border control for spaces where securities need to be ensured, such as a control of entrance-exit of a room, log-in control of a personal computer, log-in control of a cell phone, and control of entry-exit of a country. Further, in addition to the security purpose, it is possible to apply the present invention to a system required for service operations such as working management or check of double registration of identification.

The present application claims priority based on Japanese Patent Application No. 2008-266792 (filing date: Oct. 15, 2008), all of which disclosure is incorporated herein by reference.

1. A pattern matching device, comprising:
an image obtaining unit that obtains an image of a subject containing a plurality of types of biometric patterns;
a separation-and-extraction unit that separates and extracts a plurality of types of the biometric patterns from the image; and,
a matching unit that matches each of the separated and extracted plurality of types of the biometric patterns against biological information for matching registered in advance to derive a plurality of matching results.

2. The pattern matching device according to claim 1, wherein
a pixel in the image is expressed by an image vector including each density value of a plurality of color components contained in the image as an element; and,
the separation-and-extraction unit obtains a biometric base vector corresponding to any of the plurality of types of the biometric patterns, calculates an inner product of the biometric base vector and the image vector, and obtains the thus calculated value as the density value of the biometric pattern, thereby to separate and extract the biometric pattern from the image.

3. The pattern matching device according to claim 2, further comprising:
a biometric pattern storing unit that stores the biometric pattern;
a multivariate analysis unit that subjects the biometric pattern obtained from the biometric pattern storing unit to a multivariate analysis to calculate the biometric base vector; and,
a base vector storing unit that stores the biometric base vector calculated by the multivariate analysis unit; wherein
the separation-and-extraction unit obtains the biometric base vector from the base vector storing unit.

4. The pattern matching device according to claim 3, wherein
the multivariate analysis unit implements any of an independent component analysis, a principal component analysis and a discriminant analysis as the multivariate analysis.

5. The pattern matching device according to claim 2, further comprising:
a biological-information-for-matching storing unit that stores the biological information for matching, wherein
the matching unit obtains a plurality of types of the biological information for matching from the biological-information-for-matching storing unit.

6. The pattern matching device according to claim 2, wherein
the subject is a finger;
the biometric pattern includes a fingerprint pattern, which is a fingerprint image of the finger, and a blood vessel pattern, which is a blood vessel image of the finger; and,
the biometric base vector includes a fingerprint base vector for extracting the fingerprint pattern, and a blood vessel base vector for extracting the blood vessel pattern.

7. The pattern matching device according to claim 6, wherein
the biological information for matching includes a fingerprint pattern for matching, which is used for matching the fingerprint pattern, and a blood vessel pattern for matching, which is used for matching the blood vessel pattern.

8. The pattern matching device according to claim 6, wherein
the biological information for matching includes fingerprint feature information for matching, which represents a feature of the fingerprint pattern, and blood vessel feature information for matching, which represents a feature of the blood vessel pattern.

9. The pattern matching device according to claim 6, wherein
the matching unit includes a frequency DP matching unit that:
calculates Fourier amplitude spectrum, as a feature amount, that is obtained by subjecting at least one of the fingerprint pattern and the blood vessel pattern to a one-dimensional Fourier transform;
extracts a principal component of the feature amount by using the principal component analysis;
calculates a similarity through a DP matching on the basis of the principal component of the feature amount; and,
obtains the similarity as a matching result.

10. The pattern matching device according to claim 9, wherein
the matching unit includes minutia matching unit that:
extracts a feature point formed by a ridge of a fingerprint, and a bifurcate point and an ending point of the ridge from the fingerprint pattern;
calculates a similarity on the basis of the feature point; and,
obtains the similarity as a matching result.

11. The pattern matching device according to claim 10, wherein
the matching unit matches the fingerprint pattern by the minutia matching unit, and matches the fingerprint pattern and the blood vessel pattern by the frequency DP matching unit.

12. The pattern matching device according to claim 2, further comprising a matching result integration unit that integrates a plurality of the matching results.

13. The pattern matching device according to claim 12, wherein
the matching result integration unit multiplies the matching result derived by the matching unit by a predetermined weighting coefficient, and combines them.

14. The pattern matching device according to claim 2, wherein
the image is a multispectral image formed by at least four color components; and,
a pixel of the biometric pattern extracted by the separation-and-extraction unit is expressed by an inner product calculation of the biometric base vector and the image vector in at least four dimensions or more.

15. The pattern matching device according to claim 14, wherein
the image obtaining unit includes:
a plurality of half-mirrors that separate an optical path of a light through an imaging lens into at least four paths;
a bandpass filter that passes a light having a wavelength band different for each of the optical paths separated by the plural half-mirrors; and,
an imaging device that receives a light passing through the bandpass filter, and captures the multispectral image.

16. The pattern matching device according to claim 14, wherein
the image obtaining unit includes:
a half-mirror that separates an optical path of a light through an imaging lens into at least two optical paths;
an infrared ray cutting filter that blocks an infrared ray contained in a light of one optical path of the at least two optical paths separated by the half-mirror;
a bandpass filter that passes almost a half wavelength band of each of red, blue and yellow wavelength band contained in a light of the other optical path of the at least two optical paths separated by the half-mirror;
a dichroic prism that separates each of the light passing through the infrared ray cutting filter and the light passing through the bandpass filter into the red, blue and yellow wavelength bands; and
an imaging device that receives each of the lights separated by the dichroic prism, and captures the multispectral image.

17. A pattern matching method, comprising:
obtaining an image of a subject containing a plurality of types of biometric patterns;
separating and extracting a plurality of types of the biometric patterns from the image;
matching each of the separated and extracted plurality of types of the biometric patterns against biological information for matching registered in advance to derive a plurality of matching results.

18. The pattern matching method according to claim 17, wherein
a pixel in the image is expressed by an image vector using each density value of plural color components contained in the image as an element; and
said separating-and-extracting the plurality of types of the biometric patterns includes:
obtaining a biometric base vector corresponding to any of the plurality of types of the biometric patterns;
calculating an inner product of the biometric base vector and the image vector; and,
obtaining the thus calculated value as the density value of the biometric pattern, thereby to separate and extract the biometric pattern from the image.

19.-24. (canceled)

25. The pattern matching method according to claim 18, further including:
integrating a plurality of the matching results.

26. The pattern matching method according to claim 25, wherein
said integrating the plurality of the matching results includes multiplying the matching result derived in the matching step by a predetermined weighting coefficient and, combining them.

27. (canceled)
